(19) United States
(12) Patent Application Publication
(10) Pub. No.: US 2023/0213337 A1
(43) Pub. Date: Jul. 6, 2023

(54) LARGE-SCALE FOREST HEIGHT REMOTE SENSING RETRIEVAL METHOD CONSIDERING ECOLOGICAL ZONING

(71) Applicant: Wuhan University, Wuhan (CN)

(72) Inventors: Zhaocong WU, Wuhan (CN); Fanglin SHI, Wuhan (CN)

(21) Appl. No.: 18/093,828

(22) Filed: Jan. 6, 2023

(30) Foreign Application Priority Data
Jan. 6, 2022 (CN) 202210010394.3

(51) Int. Cl. G01C 11/04; G06F 18/214

(52) U.S. Cl. CPC G01C 11/04; G06F 18/214

(57) ABSTRACT

A large-scale forest height remote sensing retrieval method includes: acquiring Ice, Cloud and land Elevation Satellite (ICESAT-2) tree height data, Landsat data, Shuttle Radar Topography Mission (SRTM) data, Worldclim data, forest type data and ecological zoning data within a target zone, and preprocessing the data; carrying out georeferencing on the processed data to generate a first data set; calculating spectral features, terrain features and climatic factor features of an image, and combining the calculated features with the ecological zoning data and the forest type data to obtain a second data set; extracting eigenvalues of a same geographical location from the second data set, and combining the extracted eigenvalues with the tree height data to generate training data; constructing a random forest model covering a large zone as an ecological zoning tree height retrieval model, and dividing the obtained training data into a training sample and a verification sample.

### CROSS-REFERENCE TO RELAYED APPLICATIONS

Pursuant to 35 U.S.C. § 119 and the Paris Convention Treaty, this application claims foreign priority to Chinese Patent Application No. 202210010394.3 filed Jan. 6. 2022, the contents of which, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to the field of remote sensing in forestry, and more particularly, to a remote sensing inverse method for retrieving the height of trees in a large-scale forest.

Forest height is an important attribute in forest resource surveys, forest productivity, and biodiversity, and a key factor in estimating forest biomass and forest carbon sinks. Consistent, accurate and large-scale forest height estimates are essential for estimating forest-related carbon emissions, analyzing forest degradation, and quantifying the effectiveness of forest restoration programs. Traditionally, Forest heights have been measured in the field, but this method is labor intensive. Lately, airborne lidar has become an accurate way to measure spatially continuous Forest height. However, it also a challenge in forest height mapping on a large scale, due to its expensive data collection, and differences in data collection time and parameters on large scales. A satellite LiDAR system uses a laser ranging technology to directly determine a three-dimensional vertical structure of a large-scale forest, are more suitable than airborne lidars for forest height mapping over large areas. However, due to satellite orbit design, existing and planned satellite-borne LiDAR systems cannot directly make a continuous high-spatial resolution map of the tree height of the large-area forest. Therefore, it is necessary to develop a forest height estimation method for correlating a discrete sparse dot LiDAR footprint with a spatially continuous auxiliary variable.

The use of spatially-continuous satellite images to upgrade satellite LiDAR forest heights of discrete point states to a region-continuous level has become a hot topic in large-scale forest height mapping. Various mathematical methods are currently available for upgrading forest heights with additional ancillary variables. Most of them can construct a single model of a large-scale forest region to estimate the forest height. Since forest growth is spatially variable, the traditional construction of a single model will limit the accuracy of forest height estimation. In addition, a single model may not be appropriate for a large forest area since the forest height model vary across forest species. Therefore, it is necessary to develop forest height models for different forest zones. Traditionally, forest zones are usually divided based on fixed sizes, where the influence of local climate and topography on forest growth are neglected and thus the accuracy of forest height estimates is affected. Given the complex ecological environment, vast forest area, climate and vegetation differences in different ecological zones of the world, there is a need to develop a multi-source remote sensing forest height model that takes into account different ecological zones and different forest types. The proposed ecological zone-based forest height modeling approach takes into account not only forest species, but also climate and topographical factors that affect forest height modeling, which can help to understand the differences in these forest heights across ecological zones, and realize rapid and high-precision estimation for a continuous forest height mapping in a large-area complex forest ecosystem, and facilitate accurate studies of carbon sinks in the world's forests.

### SUMMARY

Directed at problems that current large-scale forest height estimation algorithms are low in accuracy and poor in zonal representativeness, the disclosure provides a large-scale forest height remote sensing retrieval method considering ecological zoning. According to the advantages that the growth patterns of trees are related to ecological factors (geomorphology, geology, vegetation and climate), it is necessary to describe forest dynamics by assuming ecological regional differences to improve the accuracy of prediction. A multi-source remote sensing data non-parametric tree height model considering different ecological zones and different forest types is built by combining forest ecological zoning data with satellite-borne photon counting LiDAR (ICESAT-2), optical images, terrain data, meteorological data and latitude and longitude data, and used to estimate a spatially continuous forest height of an entire research zone.

The remote sensing inverse method comprises:

step 1: acquiring ICESAT-2 tree height data, Landsat data, SRTM data, Worldclim data, forest type data and ecological zoning data within a target zone, and preprocessing the data;

step 1.1: collecting the Landsat data, the SRTM data, the Worldclim data and the forest type data within the target zone;

step 1.2: employing a data quality layer in a cloud masking method CFmask to remove cloud and cloud shade pixels from the Landsat image to obtain high-quality Landsat data;

step 1.3: resampling the SRTM data and the Worldclim data to be consistent with Landsat resolution;

step 1.4: carrying out category data re-encoding on each category of the forest type data to obtain a forest type 1, a forest type 2, a forest type 3 . . . a forest type M with corresponding codes 1, 2, 3 . . . , M respectively;

step 1.5: acquiring the ICESAT-2 tree height data within the target zone, and employing terrain filtering, canopy height filtering and photon number filtering to remove low-quality laser spot data to obtain high-precision tree height data Hcanopy and a longitude and latitude coordinate of a corresponding spot center; and

step 1.6: collecting the ecological zoning data within the target zone to obtain a boundary range of each ecological zone, wherein N sub-ecological zones are comprised in total, carrying out category data re-encoding on each sub-ecological zone to obtain an ecological zone 1, an ecological zone 2, an ecological zone 3 . . . an ecological zone N with corresponding codes 1, 2, 3 . . . , N respectively;

step 2: carrying out georeferencing on the processed Landsat data, SRTM data, Worldclim data, forest type data and ecological zoning image data to generate a first data set;

step 3: calculating spectral features, terrain features and climatic factor features of an image according to the first data set, and combining the calculated features with the ecological zoning data and the forest type data to obtain a second data set;

step 4: extracting eigenvalues of a same geographical location from the second data set by using a latitude and longitude coordinate of a spot center corresponding to the ICESAT-2 tree height data, and combining the extracted eigenvalues with the tree height data to generate training data;

step 5: constructing a random forest model covering a large zone as an ecological zoning tree height retrieval model, and dividing the obtained training data into a training sample and a verification sample, wherein the training sample is used to train the model, and the verification sample is used to verify the model; and

step 6: estimating a spatially-continuous forest height of an entire research zone by using the ecological zoning tree height retrieval model trained in step 5 to obtain a tree height spatial distribution map.

Further, in step 3, the spectral features of a Landsat image comprise six original spectral wavebands B2, B3, B4, B5, B6 and B7, an normalized differential vegetation index (NDVI), a difference vegetation index (DVI), a ratio vegetation index (RVI), a soil-adjusted vegetation index (SAVI), an enhanced vegetation index (EVI), a leaf area index (LAI), a tasseled cap brightness TCB, a tasseled cap greenness TCG, a tasseled cap wetness TCW, a Contrast texture, a Dvar texture and an Inertia texture; the terrain features of SRTM comprise a terrain altitude DEM, a slope, an aspect, and hill shades under the solar azimuth angles of 0°, 60°, 120°, 180°, 240° and 300°; the climatic factor features of Worldclim comprise 19 biologically-related climatic factors bio1-bio19; thus, the finally-obtained second data set comprises a total of 48 features consisting of the ecological zoning data, 18 spectral features, 9 terrain features, 19 climatic factors and the forest type data.

Further, in step 4, a total of 50 eigenvalues are extracted from a same geographical location, and comprise longitude, latitude, re-encoded forest type number, reencoded ecological zoning number, B2, B3, B4, B5, B6, B7, NDVI, DVI, RVI, SAVI, EVI, LAI, TCB, TCG, TCW, Contrast, Dvar, Ierita, DEM, slope, aspect, hillshade 0°, hillshade 60°, hillshade 120°, hillshade 180°, hillshade 240°, hillshade 300° and bio1-bio19.

The following advantages are associated with the remote sensing inverse method of the disclosure:

1) Compared with the building of only one forest height estimation model in a research zone currently, in this disclosure, by full consideration for ecological factors related to forest growth, ecological zoning factors are incorporated into forest height modeling to obtain a remote sensing-ecologically-coupled forest height estimation model, which can highlight different ecological zoning models factors (optical spectral band, vegetation index, texture, terrain, climate, latitude and longitude, etc.) contributions, and a rich and nuanced understanding in forest height estimation.

2) An ecological zoning method may be implemented by carrying out spatial division according to ecosystem types and geographic features related to forest growth, instead of adopting arbitrary geometric scale zoning, the method also allows the capture and analysis of the unique relationships of forest growth of each ecological region in most forest conditions, so that an analysis and application on forest height production is of practical significance.

3) The remote sensing-ecologically-coupled forest height estimation model may be used to quantize an error of a forest canopy height in a single ecological zone, thereby defining the uncertainty of the model under different ecological zone conditions; While the non-ecological zoning model is prone to wrap uncertainties from individual ecological zones, which reduces the overall accuracy of the model performance.

### BRIEF DESCRIPTION OF THE DRAWINGS

FIG. 1 is a flow chart of an embodiment of the disclosure; and

FIG. 2 is an example of ecological zoning in the eastern region of China according to an embodiment of the disclosure; and

FIG. 3 is an example of the mapped forest height in the eastern monsoon ecozone of China according to an embodiment of the disclosure.

### DETAILED DESCRIPTION OF THE EMBODIMENTS

The disclosure provides a large-scale forest height remote sensing retrieval method considering ecological zoning. The following further describes the technical solution of the disclosure with reference to Landsat8 image data of the eastern region of China in 2019 and a random forest model constructed by the Google Earth Engine, and in combination with accompanying drawings and embodiments.

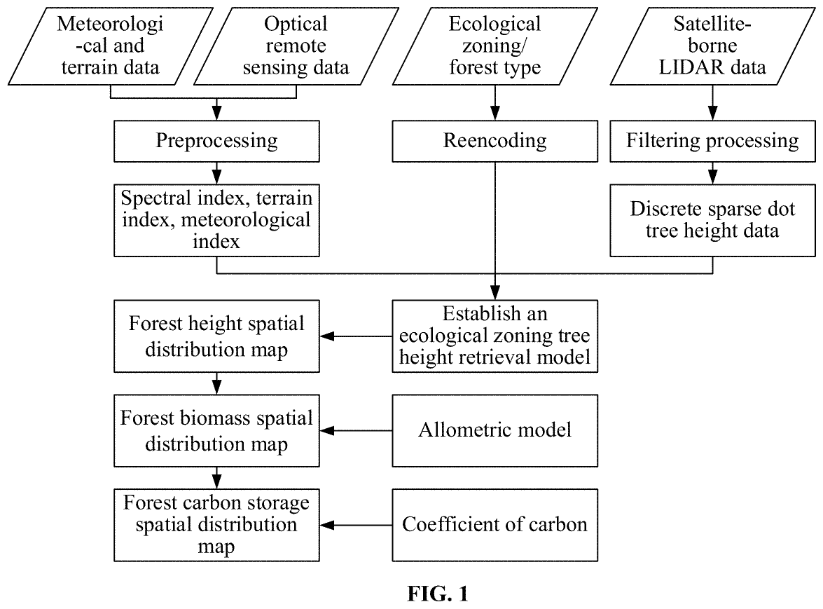

As shown in FIG. 1, a flow of an embodiment of the disclosure comprises.

At step 1: ICESAT-2 tree height data, Landsat data, SRTM data, Worldclim data, forest type data and ecological zoning data within a target zone are acquired, and then these data are preprocessed, where step 1 specifically comprises:

at step 1.1: the Landsat data, SRTM data, Worldclim data and forest type data of the eastern region of China in 2019 are collected by using the Google Earth Engine;

at step 1.2: a data quality layer in a cloud masking method CFmask is employed to remove cloud and cloud shade pixels in a Landsat image to obtain high-quality Landsat data;

at step 1.3: the SRTM data and the Worldclim data are resampled to a 30 m resolution;

at step 1.4: each category of the forest type data is subjected to category data re-encoding to obtain codes 1, 2, 3 respectively corresponding to a coniferous forest, a broad-leaved forest and a mixed broadleaf-conifer forest;

at step 1.5: the ICESAT-2 tree height data of the year 2019 is acquired, and low-quality laser spot data is removed by using terrain filtering, canopy height filtering and photon number filtering, so as to obtain high-precision tree height data Hcanopy and a longitude and latitude coordinate of a corresponding spot center; and

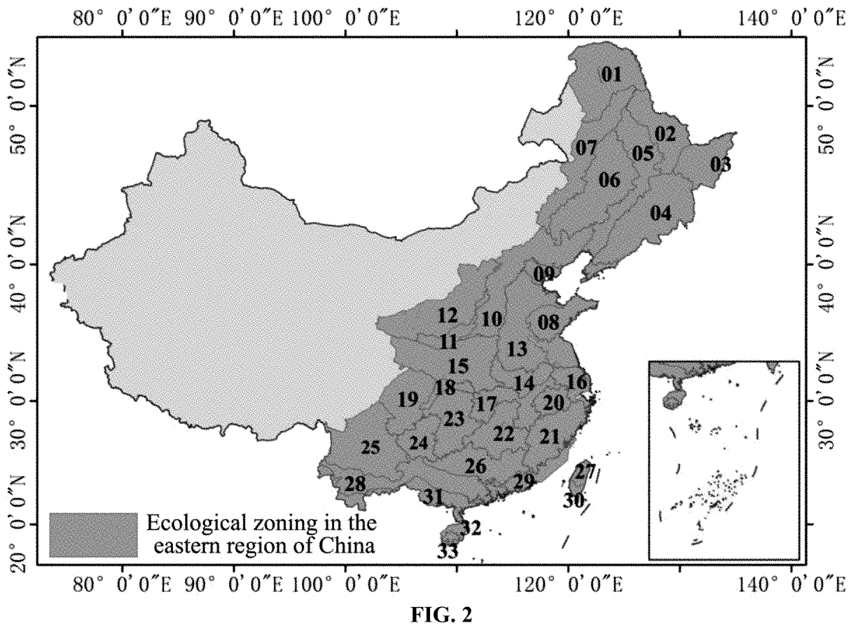

at step 1.6: the ecological zoning data of the eastern region of China is collected to obtain a boundary range of each ecological zone, where 33 sub-ecological zones are included in total, and uploaded to the Google Earth Engine. As shown in FIG. 2, each sub-ecological zone is subjected to category data re-encoding to obtain an ecological zone 1, an ecological zone 2, an ecological zone 3 . . . an ecological zone 33 with corresponding codes 1, 2, 3 . . . , 33 respectively.

At step 2: the Landsat data, SRTM data, Worldclim data and forest type data of the corresponding ecological zones are respectively extracted from the Google Earth Engine to generate a first data set. The data format of the first data set is shown in Table 1.

TABLE 1
Data Format of the First Data Set

| Number of | | | | | Forest |
|---|---|---|---|---|---|
| Ecological | | Landsat | SRTM | Worldclim | Type |
| Zones | Ecological Zones type | Data | Data | Data | Data |
| 1 | Mountain deciduous | raw | raw | raw | raw |
| | coniferous forest ecoregion in | raster | raster | raster | raster |
| | northern Greater Khingan | image | image | image | image |
| | Mountains | | | | |
| 2 | Ecoregion of coniferous | raw | raw | raw | raw |
| | broad-leaved mixed forest in | raster | raster | raster | raster |
| | Lesser Khingan Mountains | image | image | image | image |
| 3 | Agriculture and wetland | raw | raw | raw | raw |
| | ecological area in Sanjiang | raster | raster | raster | raster |
| | Plain | image | image | image | image |
| . . . | . . . | . . . | . . . | . . . | . . . |
| 33 | Hainan central mountain | raw | raw | raw | raw |
| | tropical rain forest and | raster | raster | raster | raster |
| | monsoon rain forest ecological | image | image | image | image |
| | zone | | | | |

At step 3, spectral features, terrain features and climatic factor features of an image are calculated according to the first data set, and then combined with the ecological zoning data and the forest type data to obtain a second data set.

Where, the spectral features of the Landsat image comprise six original spectral wavebands (B2, B3, B4, B5, B6 and B7), a normalized differential vegetation index (NDVI), a difference vegetation index (DVI), a ratio vegetation index (RVI), a soil-adjusted vegetation index (SAVI), an enhanced vegetation index (EVI), a leaf area index (LAI), a tasseled cap brightness TCB, a tasseled cap greenness TCG, a tasseled cap wetness TCW, a Contrast texture, a Dvar texture and an Inertia texture.

The terrain features of SRTM comprise a terrain altitude DEM, a slope, an aspect, and hill shades under the solar azimuth angles of 0°, 60°, 120°, 180°, 240° and 300°.

The climatic factor features of Worldclim comprise 19 biologically-related climatic factors bio1-bio19.

Thus, the finally-obtained second data set comprise a total of 48 features consisting of the ecological zoning data, 18 spectral features, 9 terrain features, 19 climatic factors and the forest type data.

TABLE 2
Data format of the second data set

| Number of | | | | |
|---|---|---|---|---|
| ecological | | | | Forest type |
| zones | Landsat data | SRTM data | Worldcli data | data |
| 1 | 18 spectral | 9 terrain | 19 climatic | raw raster |
| | features | features | factors | image |
| 2 | 18 spectral | 9 terrain | 19 climatic | raw raster |
| | features | features | factors | image |
| 3 | 18 spectral | 9 terrain | 19 climatic | raw raster |
| | features | features | factors | image |
| . . . | . . . | . . . | . . . | . . . |
| 33 | 18 spectral | 9 terrain | 19 climatic | raw raster |
| | features | features | factors | image |

At step 4, eigenvalues of a same geographical location are extracted from the second data set by using the latitude and longitude coordinate of a spot center corresponding to the high precision tree height data Hcanopy extracted using ICESAT-2, and then combined with Hcanopy to generate training data.

A total of 50 eigenvalues are extracted from a same geographical location, comprising longitude, latitude, re-encoded ecological zoning number, B2, B3, B4, B5, B6, B7, NDVI, DVI, RVI, SAVI, EVI, LAI, TCB, TCG, TCW, Contrast, Dvar, Ierita, DEM, slope, aspect, hillshade 0°, hillshade 60°, hillshade 120°, hillshade 180°, hillshade 240°, hillshade 300°, bio1-bio19 and forest type.

At step 5: a random forest model covering a large area is constructed as an ecological zoning tree height retrieval model, the obtained training data is divided into a training sample and a verification sample, where the training sample is configured to train the model, and the verification sample is configured to verify the model.

By taking the features extracted in step 4 as prediction variables and taking the Hcanopy extracted by ICESat-2 as response variables, the training data is divided into a training sample and a test sample at a ratio of 7:3, the training sample is used to train the random forest model, and the test sample is used to test the random forest model, so as to obtain an ecological zoning tree height retrieval model.

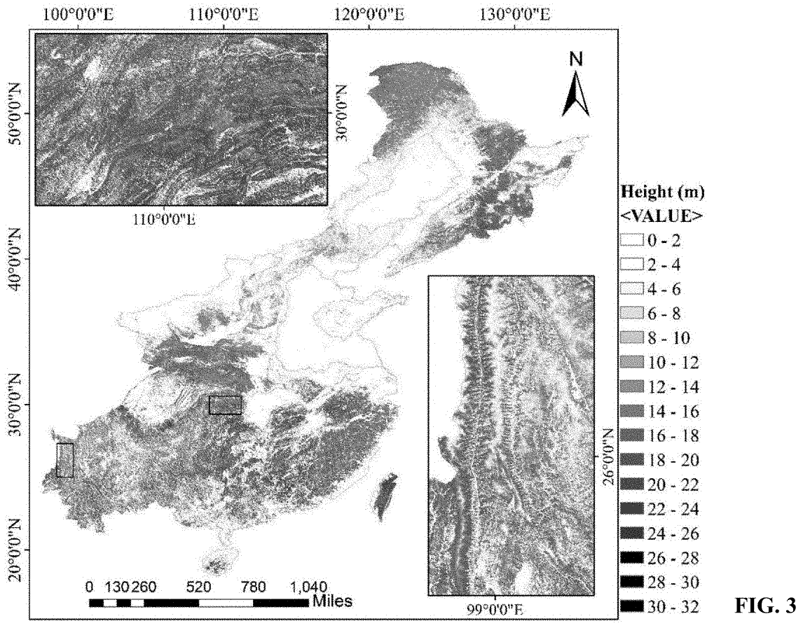

At step 6: a spatially-continuous forest height of an entire research zone is estimated by using the ecological zoning tree height retrieval model trained in step 5. Each pixel value of the second data set (including latitude, re-encoded ecological zoning number, B2, B3, B4, B5, B6, B7, NDVI, DVI, RVI, SAVI, EVI, LAI, TCB, TCG, TCW, Contrast, Dvar, Ierita, DEM, slope, aspect, hillshade 0°, hillshade 60°, hillshade 120°, hillshade 180°, hillshade 240°, hillshade 300°, bio1-bio19 and forest type) in step 3 is substituted into the ecological zoning tree height retrieval model, and the ecological zoning tree height retrieval model is run in Google Earth Engine, so as to obtain a prediction value of each pixel of forest height, finally obtaining a continuous forest height distribution map of the eastern region of China in 2019, as shown in FIG. 3.

During specific implementation, the above flow may automatically run by using a computer software technology.

The specific embodiments described herein are only examples to illustrate the spirit of the disclosure. Those skilled in the art may make various amendments or supplements to the specific embodiments described or replace them in similar ways without deviating from the spirit of the disclosure or going beyond the scope defined in the appended Claims.

What is claimed is:

1. A large-scale forest height remote sensing retrieval method, the method comprising:
step 1: acquiring Ice, Cloud and land Elevation Satellite (ICESAT-2) tree height data, Landsat data, Shuttle Radar Topography Mission (SRTM) data, Worldclim data, forest type data and ecological zoning data within a target zone, and preprocessing the data;
step 2: carrying out georeferencing on the processed Landsat data, SRTM data, Worldclim data, forest type data and ecological zoning image data to generate a first data set;
step 3: calculating spectral features, terrain features and climatic factor features of an image according to the first data set, and combining the calculated features with the ecological zoning data and the forest type data to obtain a second data set;
wherein, in step 3, the spectral features of a Landsat image comprise six original spectral wavebands B2, B3, B4, B5, B6 and B7, an normalized differential vegetation index (NDVI), a difference vegetation index (DVI), a ratio vegetation index (RVI), a soil-adjusted vegetation index (SAVI), an enhanced vegetation index (EVI), a leaf area index (LAI), a tasseled cap brightness TCB, a tasseled cap greenness TCG, a tasseled cap wetness TCW, a Contrast texture, a Dvar texture and an Inertia texture; the terrain features of SRTM comprise a terrain altitude DEM, a slope, an aspect, and hill shades under the solar azimuth angles of 0°, 60°, 120°, 180°, 240° and 300°; the climatic factor features of Worldclim comprise 19 biologically-related climatic factors bio1-bio19; thus, the finally-obtained second data set comprises a total of 48 features consisting of the ecological zoning data, 18 spectral features, 9 terrain features, 19 climatic factors and the forest type data;
step 4: extracting eigenvalues of a same geographical location from the second data set by using a latitude and longitude coordinate of a spot center corresponding to the ICESAT-2 tree height data, and combining the extracted eigenvalues with the tree height data to generate training data;
step 5: constructing a random forest model covering a large zone as an ecological zoning tree height retrieval model, and dividing the obtained training data into a training sample and a verification sample, wherein the training sample is used to train the model, and the verification sample is used to verify the model; and
step 6: estimating a spatially-continuous forest height of an entire research zone by using the ecological zoning tree height retrieval model trained in step 5 to obtain a tree height spatial distribution map.

2. The method of claim 1, wherein step 1 comprises the following steps:
step 1.1: collecting the Landsat data, the SRTM data, the Worldclim data and the forest type data within the target zone;
step 1.2: employing a data quality layer in a cloud masking method CFmask to remove cloud and cloud shade pixels in the Landsat image to obtain high-quality Landsat data.
step 1.3: resampling the SRTM data and the Worldclim data to be consistent with Landsat resolution;
step 1.4: carrying out category data re-encoding on each category of the forest type data to obtain a forest type 1, a forest type 2, a forest type 3 . . . a forest type M with corresponding codes 1, 2, 3 . . . , M respectively;
step 1.5: acquiring the ICESAT-2 tree height data within the target zone, and employing terrain filtering, canopy height filtering and photon number filtering to remove low-quality laser spot data to obtain high-precision tree height data Hcanopy and a longitude and latitude coordinate of a corresponding spot center; and
step 1.6: collecting the ecological zoning data within the target zone to obtain a boundary range of each ecological zone, wherein N sub-ecological zones are comprised in total, carrying out category data re-encoding on each sub-ecological zone to obtain an ecological zone 1, an ecological zone 2, an ecological zone 3 . . . an ecological zone N with corresponding codes 1, 2, 3 . . . , N respectively.

3. The method of claim 1, wherein, in step 4, a total of 50 eigenvalues are extracted from a same geographical location, and comprise longitude, latitude, re-encoded forest type number, reencoded ecological zoning number, B2, B3, B4, B5, B6, B7, NDVI, DVI, RVI, SAVI, EVI, LAI, TCB, TCG, TCW, Contrast, Dvar, Ierita, DEM, slope, aspect, hillshade 0°, hillshade 60°, hillshade 120°, hillshade 180°, hillshade 240°, hillshade 300° and bio1-bio19.
